(19) United States
(12) Patent Application Publication
(10) Pub. No.: US 2009/0119199 A1
(43) Pub. Date: May 7, 2009

(54) Loan determination method and apparatus

(75) Inventor: Al Salahi, La Canada, CA (US)

Correspondence Address: WILLIAM W. HAEFLIGER, 201 S. LAKE AVE, SUITE 512, PASADENA, CA, 91101, US

(73) Assignee: NAMEYOURLOAN

(21) Appl. No.: 12/288,279

(22) Filed: Oct. 20, 2008

Related U.S. Application Data
(60) Provisional application No. 61/001,943, filed on Nov. 7, 2007.

(51) Int. Cl. G06Q 40/00

(52) U.S. Cl. 705/37

(57) ABSTRACT

The method of determining the best mortgage loan interest rate, that includes the steps, selecting a group of bid participating banks, and/or mortgage lenders willing to participate in a generally simultaneous, or by a deadline, bid competition, causing the group to submit generally simultaneous, or by deadline, available and quoted loan rate bids to compete, allowing members of the group to revise said quoted rates after review of other member quoted rates, and selecting one of said submitted bids as a winning low rate loan bid.

This application claims priority from provisional application Ser. No. 61/001,943, filed Nov. 7, 2007.

### BACKGROUND OF THE INVENTION

This invention relates generally to establishing favorable loan rates of interest, and more particularly to a method of determining the most favorable, or best, loan rate as a result of auction bidding procedures.

There is need for efficiently and effectively establishing most favorable loan rates from a selected group of loan source institutions such as banks, mortgage lenders, and the like. In particular, there is need for enhancing competition in competitive loan rate bidding procedures.

### SUMMARY OF THE INVENTION

It is a major object of the invention to provide an improved and highly efficient procedure to establish a most favorable mortgage loan interest rate, when a number of bidders are involved. Basically, the method of the invention comprises:

a) selecting a group of bid participating banks, and/or mortgage lenders willing to participate in a generally simultaneous, or by a deadline, bid competition,

b) causing said group to submit generally simultaneous, or by a deadline, available and quoted loan rate bids to compete,

c) allowing members of the group to revise said quoted rates after review of other member quoted rates,

d) and selecting at least one of said submitted bids as a potentially winning low rate loan bid.

There are currently online mortgage referral services that claim “lender competition”. However, in reality their claim is unrealistic because they simply collect the borrower's information and sell it to any lender who pays them top dollar for it. There is no real competition, and borrowers almost always receive phone calls from lenders who have paid money to obtain the borrower's phone numbers.

There is need for a method whereby participating lenders and banks must first compete with one another and only then, those lenders with the most competitive loan offer get a chance to win the borrower's business.

As will be seen, the method steps of the present invention are typically effected via internet protocol.

A further object is to provide step sequences, or parts thereof, as are disclosed herein.

These and other objects and advantages of the invention, as well as the details of an illustrative embodiment, will be more fully understood from the following specification and drawings, in which:

### DRAWING DESCRIPTION

FIG. 1 is a block diagram showing lender registration workflow steps;

FIG. 2 is a block diagram showing borrower registration workflow steps;

FIG. 3 is a block diagram showing standard loan auction workflow steps;

FIG. 4 is a block diagram showing structure loan auction workflow steps;

FIG. 5 is a block diagram showing bidding process steps; and

FIG. 6 is a block diagram showing winner calculation steps.

### DETAILED DESCRIPTION

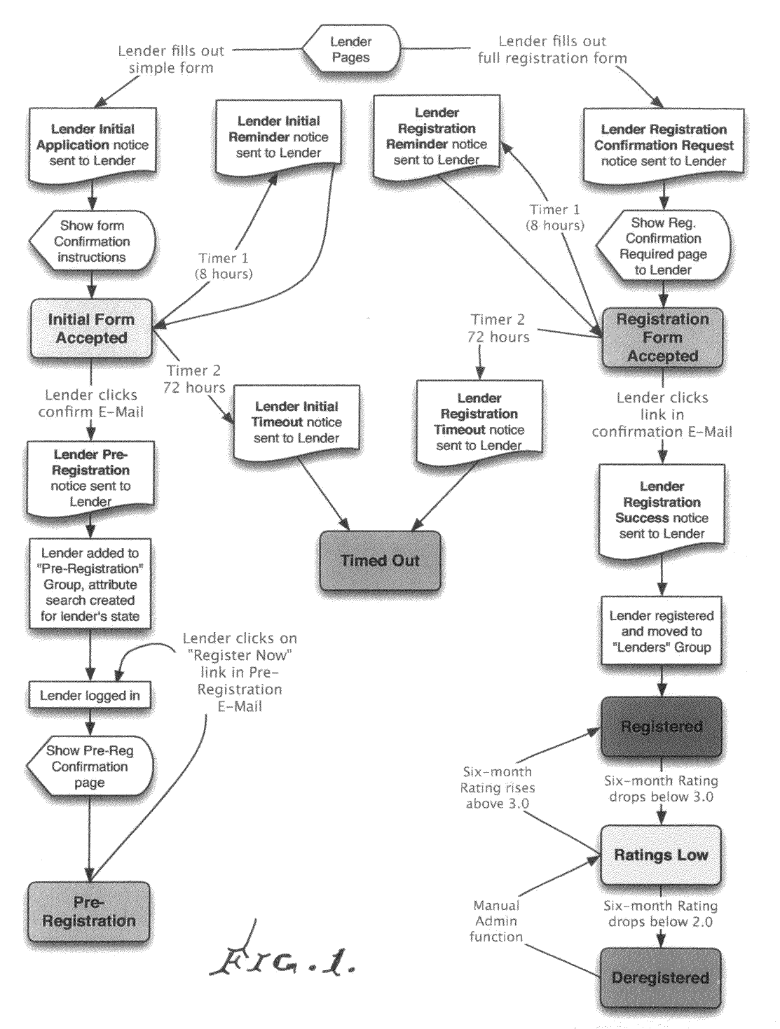

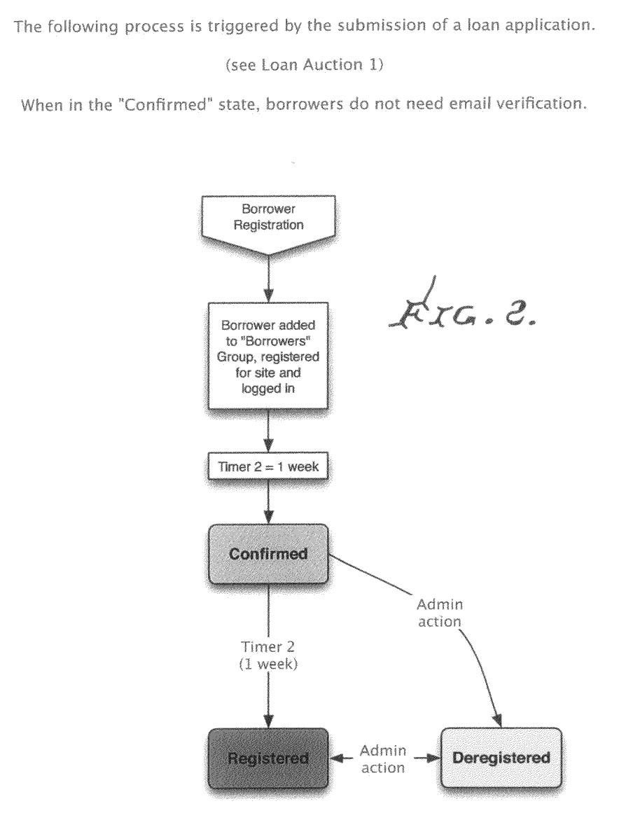

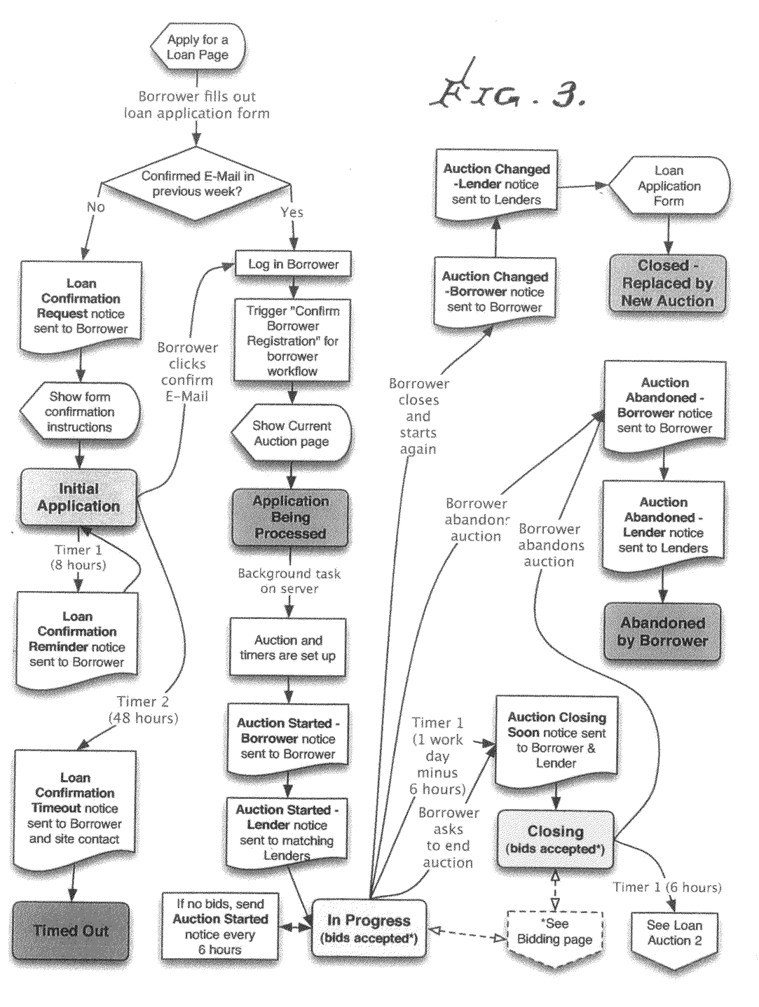

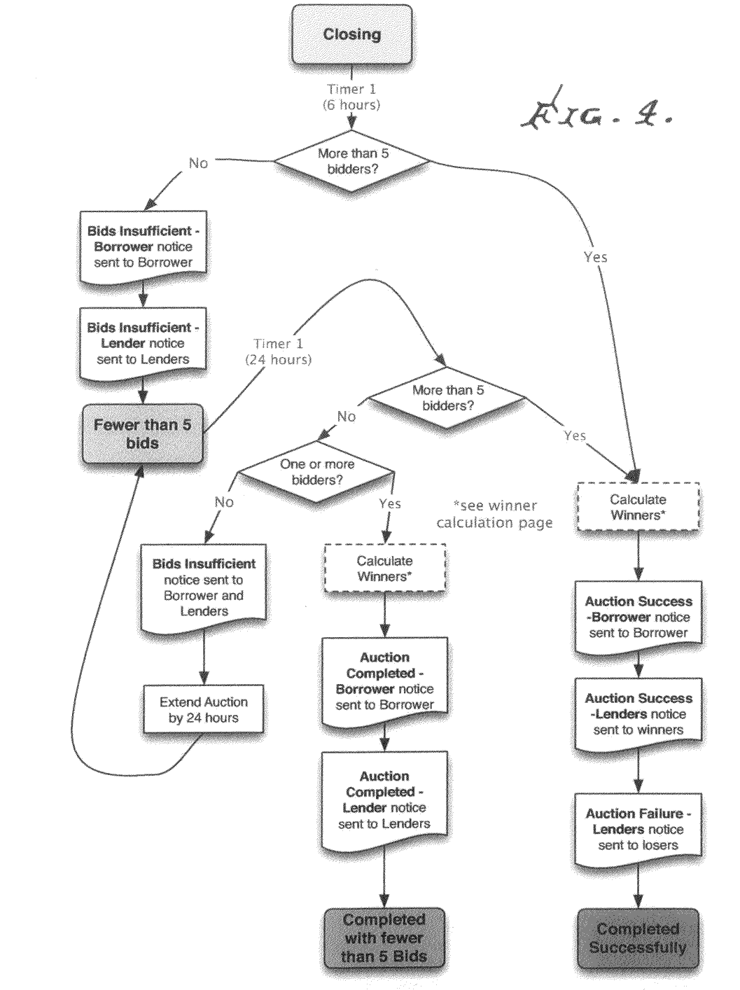

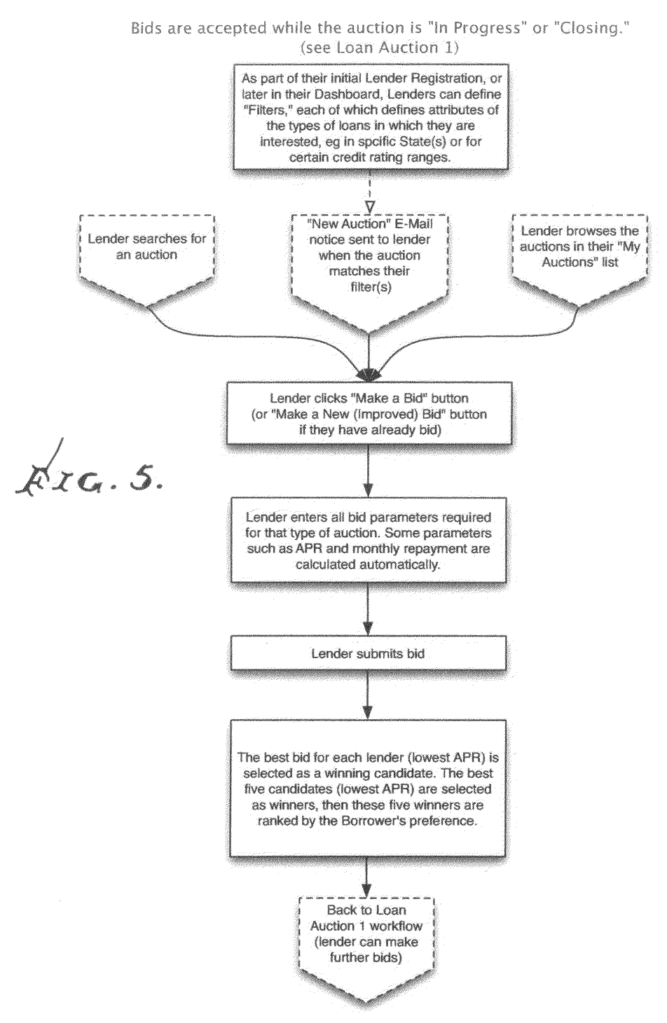

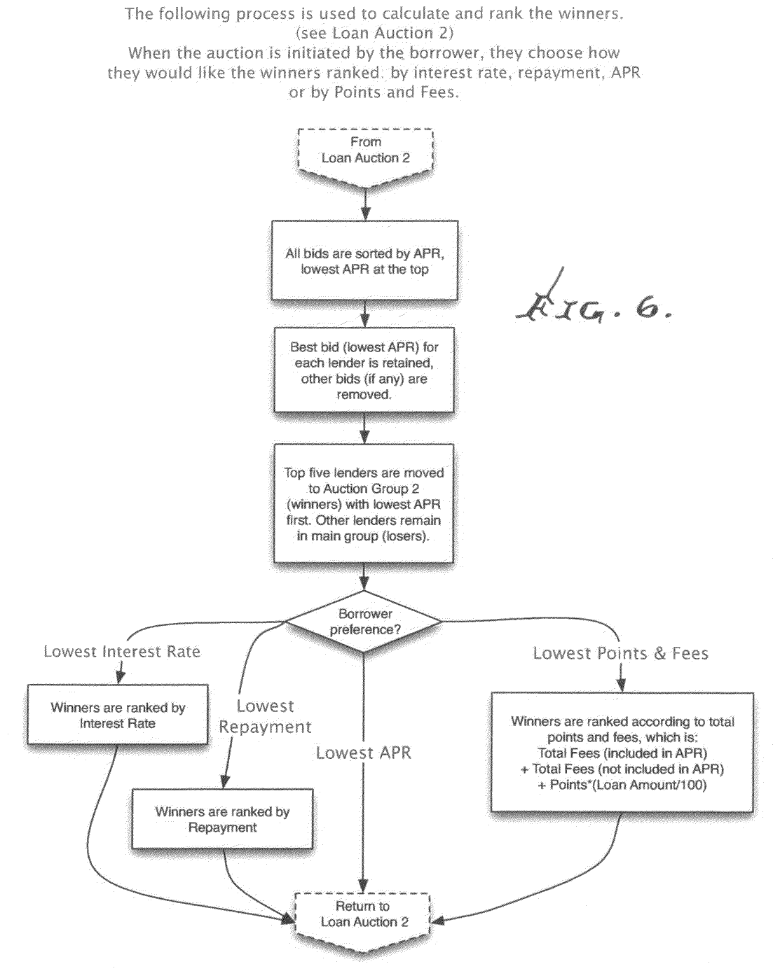

FIGS. 1-6 show sequences of steps which may be included in the basic method of determining the best preferred mortgage interest rate offered by lending institution, and including the method steps:

a) selecting a group of bid participating banks, and/or mortgage lenders willing to participate in a generally simultaneous, or by a deadline, bid competition,

b) causing said group to submit generally simultaneous, or by a deadline, available and quoted loan rate bids to compete,

c) allowing members of the group to revise said quoted rates after review of other member quoted rates,

d) and selecting one of said submitted bids as a winning low rate loan bid.

Typically, the auction continues for up to 24 hours, unless borrowers decide to terminate it sooner. Throughout the course of the auction, all loan offers are displayed online and borrowers can log in at any time to view their auction status/results. Upon conclusion of the auction, out of all the bids that have been submitted by multiple lenders and banks, the lowest offer is announced the “winner” and four runner ups and considered “back up winners”.

As an example, method steps of one example of the present invention may typically include the following:
1. Click on your desired loan choice on the home page (Purchase, Refinance or Equity loan);
2. Complete the short application that applies to you on our secure site. (Please note that Mortgages are usually the most important financial transaction for most people, treat it accordingly and take time to complete your application fully and accurately to receive the best results);
3. Once you submit your application, you will receive an email that will ask you to confirm your inquiry and email address. You must respond to that email in order to activate your Online Mortgage Auction and begin receiving competitive offers;
4. As soon as you respond to your confirmation email, the detail of your loan request will immediately be sent electronically to numerous certified national and local banks & lenders;
5. Once lenders receive and review the details of your loan request, they will start placing their offers/bids online which will be posted on your auction page at NameYourLoan.com. Lenders must include interest rate as well as all the fees associated with the loan they are offering;
6. In your loan request, you are asked to specify what is most important to you in the loan you are looking for. For example, is it lowest interest rate and payment; or is it lowest fees and cost; or do you prefer a combination of both? Lenders place their bids accordingly;
7. Once bids are received from lenders, sophisticated and state of the art computer technology process them and calculate the best offers/bids and list them on your auction page in that order. This powerful system is like shopping the entire market with one click and then, having a personal financial expert to sort through every detail of all loan offers to pick out the best;
8. You will receive email updates or can at anytime simply log in at NameYourLoan.com to view your auction status/results on your dashboard;
9. Auctions normally run for 24 hours (weekdays), at which time the lender with the lowest offer is announced Winner and the four runner up lends are considered back up winners. In order to make sure you receive adequate offers/bids from lenders, the 24 hour auction period does not include weekends. In other words, if you start an auction close to, or over the weekend, although your auction starts immediately, it will not terminate until 24 weekday hours have passed;
10. You can always extend your auction beyond 24 hours if you wish to receive additional offers/bids. Also, you can always terminate your auction at any time before 24 hours, if you are satisfied with the offers/bids that you have received up to that point;
11. During the entire auction process, you have access to every lender's contact information, but lenders do not have access to your contact information;
12. At the conclusion of the auction, only the lowest five lenders (Winner & 4 back up winners) receive your contact information;
13. You communicate with these lenders and get the best loan;

14. Using NameYourLoan.com's innovative and protected Online Mortgage Auction allows you to shop the entire market and get the best deal with the click of a mouse and without ever haggling with lenders.

Further selection ramifications of the method may be understood from the following inquiries and explanations:
Do I need to sign up as a member before I use the method? When you make your loan request, you automatically become a member.
How do I stay informed about the status of my auction?
   We will send you emails and you can also log in and check your dashboard.
Are there any fees and/or obligations for borrowers to use this service?
   No
Are there any fees and/or obligations for lenders to use this service?
   No obligations for lenders and free during promotional period.
Who are the lenders and participate in the auctions?
   Reputable, National and local banks and lenders.
Can I rate the lender's quality of service?
   Yes. At the conclusion of the auction, you will have the opportunity to rate lenders who participated in your auction. Those who receive a less than perfect rating will be terminated from the NameYourLoan.com network.
Can my lender, friends or relatives compete in my auction?
   Yes, in fact if your lender, friends or relatives expect you to give them your loan business, you can ask them to complete in the NameYourLoan.com auction to win your business.
   Once you make your loan request at NameYourLoan.com, you will be assigned an auction number. Your lender friends or relatives can easily use that number to locate your auction on our website and place their offer for you.
Can I extend my auction beyond 24 hours?
   Yes, you must log in to do so.
Can I terminate my auction before the 24 hours?
   Yes, you must log in to do so.
Is it possible that I receive no bid?
   Yes, in which case you can always extend your auction duration.
How many bids would I receive during my auction?
   Your auction may receive lots of bids.
Can I have more than one auction at a given time?
   Yes, you can have multiple auctions running at the same time.
Can I make specific instructions for my loan request?
   Yes. When you complete your application, you will be given an area to inform the lender of specific instructions. However, keeping in mind that you should not make too many restrictive requirements as they will limit the number of lenders who will participate in your auction.
Can I view lenders' fees?
   Yes. We require that lenders include all fees associated with their loan offer, and you can view them on your auction page.
How are lender bids ranked?
   When you complete your online application, you will have an opportunity to tell lenders what is important to you. In other words, you can instruct lenders that you want to receive bids with the lowest payment, or the lowest interest rate, or the lowest cost and fees. Then lenders make their bids accordingly.
What do I do if I have questions that are not answered here?
   Please go to “Contact Us” page. When you email your inquiry to “wecare@NameYourLoan.com, you will receive a response from one of our expert representatives within 24-48 hours.

Further explanation of procedures for lenders include the following:

Once lenders sign up at NameYourLoan.com and set their filter parameters, they will be notified when there is a loan request in their desired area. Lenders can set their filters for the type of loan and geographic area.

When lenders are notified of a new loan request, they log in and place their loan offer including all fees and costs online. This process continues for 24 hours (Weekdays), while other lenders also place their bids. Throughout the course of the auction, bids are displayed and lenders and borrowers can view the auction status/results by logging in and viewing their dashboard. During the auction, lenders who have already placed bids can further improve their offer and increase their chances to win the lead. Borrowers have the option to extend their auction period beyond 24 hours, if they wish to receive additional offers/bids, or they can choose to terminate their auction sooner than 24 hours if they are satisfied with the offers/bids that they have received up to that point. In either case, participating lends will be notified by email.

At the conclusion of the auction, the lender with the lowest offer out of all the bids shall win the lead. Also, the next best four offers shall be runner up winners. In other words, you must be amongst the lowest 5 offers to win the lead. At the end of the auction, with the lowest 5 offers will receive the borrower's contact information.

Further explanation of typical procedures as respect lends include the following, in attached Exhibits A and B:

### Exhibit A

### Frequently Asked Questions

Do I need to sign up as a member before I use NameYourLoan.com?
Yes. In order to participate and get leads you must sign up for Full Membership (No cost or obligation). You can also use the quick sign up ONLY to be notified when there are new loan requests in your area.
   How do I stay informed about the status of my auction?
We will send you emails and you can also log in to check your dashboard. You can set your filter for the frequency of email updates that you want to receive.
   Are there any fees and/or obligations for lenders or borrowers to use this service?
There are no sign up or membership fees at all. Also, during the promotional period (through Mar. 31, 2008), the $19.95 per lead cost will be waived for lenders who sign up and become an approved affiliate.
   What are the steps to use NameYcurLoan.com and get quality leads?
1. Click on the “For Lenders” link;
2. Choose the “Full membership sign up” or the “Quick sign up”;
3. With “Full membership” you will be notified whenever there is a new loan request in your desired state that meets your specifications. With full membership you will be able to participate in submitting loan offers and possibly getting the lead. “Quick sign up” on the other hand will inform you whenever there is a loan request in your desired state, but you will have to first sign up as a Full member before you can submit your loan offer;
4. Once you submit your membership application, you will receive an email that will ask you to confirm your email address. You must respond to that email in order to activate your membership. You must watch for your spam filter and make sure that your confirmation email is not blocked;
5. As soon as you respond to your confirmation email, you will receive another email that contains additional useful information, including any Promotional or Voucher codes. You are now on your way to get quality leads;
6. When borrowers make a loan inquiry (Purchase loan, Refinance loan, or Equity loan) you will be notified and be given the details of the borrower's loan request in a lead sheet format;
7. With Full membership, you will be able to review the details of the borrower's loan request and then submit your loan offer online (Interest rate and fees);
8. In their original application, borrowers are asked to specify what is most important to them in the loan they are looking for. For example, is it lowest interest rate and payment; or is it lowest fees and cost; or do they prefer a combination of both (lowest APR). You will use that information to make your loan offer accordingly;
9. As bids are received from participating lenders, our sophisticated and state of the art computer technology will process and calculate the best offers and list them in that order;
10. When you first submit your loan offer, you get to see where you rank amongst other lenders. You can set your account filter to receive further email updates, or at any time simply log in to your account dashboard to view your position;
11. Auctions normally run for 24 hours (Weekdays), at which time the lender with the lowest offer is announced Winner and the four runner up lenders are announced back up winners. The 24 hour auction period does not include weekends. In other words, if an an auction starts close to, or over the weekend, it will not end until at least 24 weekday hours have passed;
12. Prior to the conclusion of the auction, you can always improve your loan offer in an attempt to move up to the winning position;
13. Borrowers can always extend the duration of their auction beyond 24 hours if they wish to receive additional offers, or terminate it at any time before 24 hours, if they are satisfied with the offers that they have received up to that point. In either case, lenders will be notified in advance;
14. During the entire auction process. borrowers have access to every lender's contact information. Lenders will get access to the borrower's contact information when they win the lead.
15. NameYourLoan.com's purpose is to empower honest, professional and competitive lenders and provide them access to a lucrative market where they get quality leads. Bate & Switch lenders hate us, but you will love us!!!
   Who are the lenders that participate in the auctions?
   Reputable, National and local lenders and banks.
      What is the licensing requirement?
   You must be a licensed lender in the states for which you wish to receive loan leads.
      Is the quality of my service rated by borrowers?
   Yes. At the conclusion of each auction, borrowers will have the opportunity to rate lenders who participated in their auction. Those who receive a less than perfect rating will be terminated from the NameYourLoan.com network.
      Do all auctions end within 24 hours?
   Auctions normally run for 24 hours (weekdays), at which time the lender who submitted the lowest offer is announced Winner and the four runner up lenders are considered back up winners. In order to make sure that lenders have adequate time to submit their loan offers, the 24 hour auction period does not include weekends. In other words, if an auction starts close to, or over the weekend, it will not terminate until at least 24 weekday hours have passed. Borrowers always have the option to extend their auction beyond 24 hours, or terminate it sooner. In either case, lenders will be notified in advance.
      Can auctions be terminated before the 24 hours?
   Yes. Borrowers can always terminate their auction prior to 24 hours. Lenders are always notified in these situations.
      How many offers am I allowed to place on any give auction?
   Unlimited. You can always improve your offer prior to the conclusion of the auction.
      When do I get the borrower's contact information?
   If you are amongst the lowest 5 lenders at the close of the auction.
      Can I ask the borrower questions during the auction?
   Yes. When placing your bid, you will be provided a comment area to communicate.
      Do I need to include estimated closing costs when I place my bid?
   Yes. We require that lenders include all fees associated with their loan offer.
      How are lender offers ranked?
   When borrowers complete their online application, they will express to lenders what is important to them in the loan that they are looking for. For instance, they may specify that they want to receive loan offers with the lowest interest rate, or the lowest points and fees, or combination of both (Lowest APR). Lenders will then make their loan offers according to the borrower's request. In order to determine the winners, NameYourLoan.com will sort all offers received from all lenders first in the order of lowest APR, and then in the order of whatever parameter the borrower has requested.
      How do I know what is happening with an auction?
   We will notify you by E-Mail. The notification frequency depends on your filter setting. You can always log in and check your dashboard.

| | | Full Membership - Bid | | |
|---|---|---|---|---|
| | | Notification setting | | |
| | Quick | Any | In/out of | |
| Event | Sign Up | Bid | Winner | Never |
| New auction starts | [symbol] | [symbol] | [symbol] | [symbol] |
| Any bid is made | | [symbol] | | |
| A bid takes you into the | | [symbol] | [symbol] | |
| top 5 | | | | |
| A bid takes you out of | | [symbol] | [symbol] | |
| the top 5 | | | | |
| Reminder - no bids yet | | [symbol] | [symbol] | [symbol] |
| No bids at close - | | [symbol] | [symbol] | [symbol] |
| auction extended by 24 | | | | |
| hours until a bid | | | | |
| Fewer than 5 bids at | | [symbol] | [symbol] | [symbol] |
| close - auction extended | | | | |
| by 24 hours, just once | | | | |
| The auction will close in | | [symbol] | [symbol] | [symbol] |
| eight hours | | | | |
| The borrower wants to | | [symbol] | [symbol] | [symbol] |
| finish early (eight hours | | | | |
| notice) | | | | |
| The borrower abandons the | | [symbol] | [symbol] | [symbol] |
| auction (perhaps to start | | | | |
| a different one) | | | | |
| The auction closes - You | | [symbol] | | [symbol] |
| may be a winner! | | | | |

do I do if I have questions that are not answered here?
Please go to “Contact Us” page. When you email your inquiry to wecare@NameYourLoan.com, you will receive a response from one of our expert representatives within 24-48 hours.

### Exhibit B

### For Lenders

1. Lenders fill out an application form online to become an approved affiliate and to be able to participate in NameYourLoan.com's Online Mortgage Auctions,
2. In their application form, lenders are asked to choose the geographic areas and the type of loans that they wish get,
3. Once lenders submit their application form, they will receive an email from NameYourLoan.com to confirm their application and email address,
4. Upon confirmation of their application and email address, they will receive an approval confirmation from NameYourLoan.com,
5. If they fail to respond to their confirmation email, they will receive reminders and ultimately if they don't respond, their application will be timed out,
6. Once they respond and are approved, any time there is a loan request that meets the lender's geographic and loan type criteria, they will be notified and asked to participate in the Online Mortgage Auction by submitting their best loan offer,
7. Once they submit their best loan offer (Includes, interest rate, terms, points, fees and costs), our sophisticated computer programs will crunch the numbers, analyze all the details of their loan offer and determine where they rank amongst other loan offers already submitted by other lenders, when lenders submit their offer, they will get to see their position,
8. Lenders can always resubmit lower offers to improve their position in an effort to with the auction,
9. Auctions normally run for 24 hours (Unless borrowers terminate sooner or extend beyond 24 hours),
10. There is no limit to the number of lenders who can participate in a given auction,
11. At the conclusion of the auction, when all said and done, the lender with the lowest offer is announced the winner of the auction and the four runner ups are announced back up winners. The remaining lenders will have to try other auctions.
12. At the conclusion of the auction, the winner and the four back up winners are given the borrower's contact information at which point they will call the borrower and the borrower will decide which one of the five lenders will get the borrower's business. These five lenders must convince the borrower that they indeed are worthy of their business in all aspects.
13. Generally, the lender who is the winner and back up winners each pay NameYourLoan.com $19.95, unless NameYourloan.com is offering promotions which may reduce the cost or eliminate it altogether,
14. Lenders who win the auction and get to work with borrowers are rated by them. If over a 6 months period lenders receive a lower than average rating, they will be eliminated from the network.

### For Borrowers

1. Borrower's registration takes place when they complete a short loan offer request application,
2. Upon completion of the application, borrowers too will receive an email to confirm their request and email address,
3. If the fail to respond, they will receive reminders and ultimately if they don't respond, their application will be timed out and cancelled,
4. Once they confirm their application and email address, the details of their loan request will be emailed to all lenders in the network who have requested this type of loan and geographic area,
5. Lenders will review the loan details and start submitting their loan offers and the auction and competition begins,
6. Borrowers can always log into their account dashboard and view their auction in progress. They can see, all the bids that has been submitted to that point, their ranking and the lender's detail,
7. Auctions normally run for 24 hours, however, at any time if the borrower is satisfied with the offers that have been submitted to that point, the borrower can terminate the auction,
8. If at 24 hours less than 5 offers are received, the auction will automatically extend for another 24 hours. Regardless of the number of offers, after the first 24 hours, borrowers can always extend the auction at their discretion,
9. When all said and done, after the completion of the auction, winning lender and back up winners are announced and given the borrower's contact information,
10. Throughout the auction, borrowers always have access to the lender's contact information. But only lenders who win or become back up winners get access to the borrower's contact information at the conclusion of the auction. This is set up this way to eliminate telephone abuse by lenders trying to contact the borrower.

I claim:

1. The method of determining the best mortgage loan interest rate, that includes the steps:
a) selecting a group of bid participating banks, and/or mortgage lenders willing to participate in a generally simultaneous, or by a deadline, bid competition,
b) causing said group to submit generally simultaneous, or by deadline, available and quoted loan rate bids to compete,
c) allowing members of the group to revise said quoted rates after review of other member quoted rates,
d) and selecting one of said submitted bids as a winning low rate loan bid.

2. The method of claim 1 wherein the steps are effected via internet protocol.

3. The method of claim 1 that includes the steps of one or more of the step sequences, or parts thereof, as defined by FIGS. 1-6 herein.

4. The method of claim 1 wherein said step c) includes providing a re-bidding process wherein certain banks and/or institution submitting bids below a certain level can re-bid at lower level or levels, in order to establish a winning bid.

5. The method of claim 1 wherein said step
c) includes providing and operating a computer or computers.

6. A system for determining the best mortgage loan interest rate, that include
a) means for selecting a group of bid participating banks, and/or mortgage lenders willing to participate in a generally simultaneous, or by a deadline, bid competition,
b) means for causing said group to submit generally simultaneous, or by deadline, available and quoted loan rate bids to compete,
c) means for allowing members of the group to revise said quoted rates after review of other member quoted rates,
d) and means for selecting one of said submitted bids as a winning low rate loan bid.

7. The system of claim 1 wherein said a), b), c) and d) means are provided in accordance with the steps of one or more of FIGS. 1-6.
